(19) United States
(12) Patent Application Publication
(10) Pub. No.: US 2006/0283643 A1
(43) Pub. Date: Dec. 21, 2006

(54) Instrument panel rib structure

(76) Inventors: Glen Simonds, London (CA); Hussein Sanaknaki, London (CA)

Correspondence Address: GREENBERG TRAURIG, LLP, 77 WEST WACKER DRIVE, SUITE 2500, CHICAGO, IL, 60601-1732, US

(21) Appl. No.: 10/569,706

(22) PCT Filed: Sep. 24, 2004
(86) PCT No.: PCT/CA04/01672

§ 371 Date: Feb. 24, 2006

(30) Foreign Application Priority Data
Sep. 24, 2003 (CA) 2,442,406

(51) Int. Cl. B62D 25/14; G06G 7/48

(52) U.S. Cl. 180/90; 703/8; 296/70; 296/72

(57) ABSTRACT

A vehicle instrument panel support structure is provided having fixing and mounting surfaces linked together by ribs in an open space frame structure. The ribs are sized, shaped and positioned to create critical load paths and eliminate the outer skin of the instrument panel support structure. Magnesium alloy material is only placed where it is needed for structure and function. The functionality of the vehicle instrument panel support structure is maintained as are the stiffness and crashworthiness when compared to the traditional design, but the weight of the instrument panel structure and the projected area are reduced. A method of designing an instrument panel support structure using a computer aided engineering platform is also provided.

### FIELD OF THE INVENTION

The invention relates to the design of an instrument panel support structure to be produced as a high pressure die cast magnesium part.

### BACKGROUND

An instrument panel (IP) support structure spans from driver's side to passenger side, rearward of the firewall or front of dash. It is fixed to the vehicle body at the A pillars and screen rail. It is also attached to the steering column tunnel via interim stamped steel brackets. The key function of the IP support structure is to fix to the vehicle body structure and support, mount, locate and/or secure key components such as steering column, passenger airbag, wiring harness, electrical modules, electronics, ducting, and dashboard fascia and trim.

A conventional die cast magnesium instrument panel support structure (FIG. 1) uses large flat surfaces or skin to support the internal ribbing structure developed to achieve the stiffness and crashworthiness performance. These large flat surfaces add to the weight of the casting and are the primary surfaces that contribute to the projected area of the part. The projected area is the surface area of the casting that is perpendicular to the die opening axis during die casting. The larger the surface area, the higher clamp tonnage the die casting machine needs to keep the die halves closed while the molten metal is shot into the cast tool. A typical cast magnesium IP support structure will weigh around 5.2 kg with a projected area of around 330,000 mm².

It may be possible to manufacture an instrument panel support as a welded steel truss system, but the resultant structure would be prohibitively heavy, and not justifiable for installation into a vehicle.

It is an object of the present invention to provide an instrument panel support structure which weighs less than conventional structures and has a smaller projected area, while maintaining the load bearing and functional performance of conventional support structures.

### SUMMARY OF THE INVENTION

An instrument panel support structure has fixing surfaces for fixation to a vehicle frame, and mounting surfaces for mounting vehicle components thereto. The fixing surfaces and the mounting surfaces are linked together by ribs to form an open space frame structure. The ribs are sized, shaped and positioned to create critical load paths within the instrument panel support structure.

A method of designing an instrument panel support structure using a computer aided engineering platform is provided commencing with the steps of inputting the positioning coordinates of selected fixing and mounting surfaces for an instrument panel support structure and inputting the performance requirements for stiffness and crashworthiness of the instrument panel support structure. The next step is linking the fixing and mounting surfaces together with ribs to form virtual open space frame. A theoretical force is applied to the open space frame and the response of the open space frame to the application of force is detected. The response is compared to the performance requirements. The open space frame is modified and these steps are re-iterated until the open space frame complies with the performance requirements for stiffness and crashworthiness; whereby a compliant virtual open space frame is created.

### BRIEF DESCRIPTION OF THE DRAWINGS

FIG. 1 is a perspective view of a prior art instrument panel support structure.

FIG. 2 is a perspective view of an instrument panel support structure in accordance with the present invention.

FIG. 3 is a perspective view of an instrument panel support structure of FIG. 2 additionally showing a steering column.

FIG. 4 is a graph of force versus time comparing the performance of the instrument panel support structure of the present invention with the prior art structure.

FIG. 5 is a perspective view of an alternative prior art instrument panel support structure.

FIG. 6 is a perspective view of an instrument panel support structure in accordance an alternative embodiment of the present invention.

FIG. 7 is a graph of force versus time comparing the performance of the instrument panel support structure of alternative embodiment of the present invention with a prior art structure.

### DETAILED DESCRIPTION OF THE INVENTION

The invention represents a new design approach to the geometry needed for the function of a light weight die cast magnesium IP support structure. The starting point in the design approach is to consider the functions which an instrument panel support structure must accomplish. There are two such functions: fixing to the vehicle framework, and securing the key instrument panel components at selected positions. In order to fulfill these functions an IP support structure must have fixing surfaces to attach it to the vehicle framework and mounting surfaces for the instrument panel components. Thus, at its most basic level, the IP support structure requires fixing surfaces and mounting surfaces which are linked together with sufficient strength to allow them to fulfill their functions. With all extraneous material removed from consideration, an IP support structure according to the present invention is comprised of fixing surfaces and mounting surfaces linked together by ribs in an open space frame structure, where the ribs are strategically placed to create critical load paths.

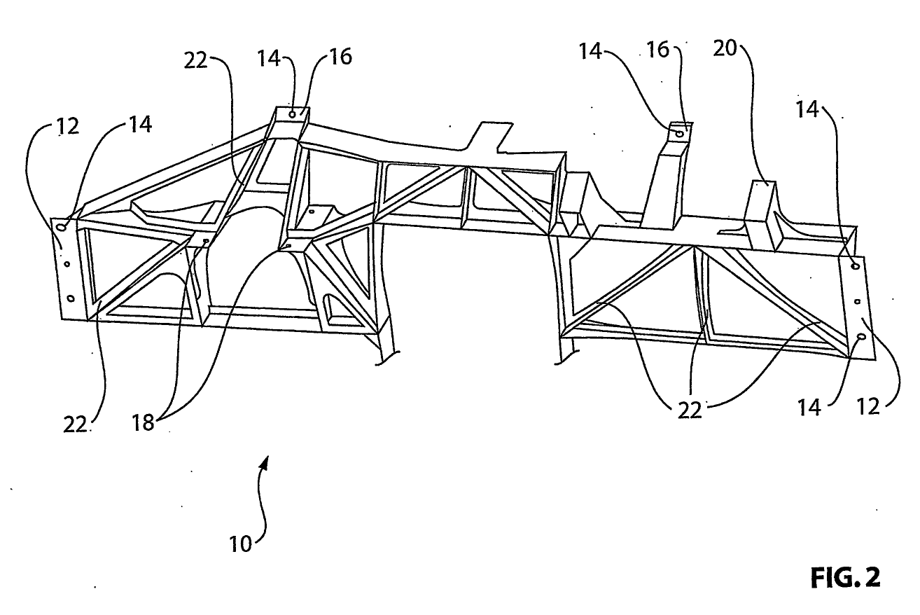

As shown in FIG. 2, the IP support structure is identified by general reference numeral 10. The IP support structure 10 spans from driver's side of the vehicle frame (not shown) to passenger side of the vehicle frame (not shown) and rearward of the firewall (at the screen rail). The IP support structure is fixed to the vehicle body (not shown) at the A pillars of the vehicle frame, to the vehicle frame rearward of the firewall (the cowl), and also to the steering column tunnel via interim stamped steel brackets. Fixing surfaces 12 have means 14 for attachment of the IP support structure 10 to the A pillars. The attachment could be accomplished in any suitable manner known in the art, such as by riveting, bolting or welding. By way of example, the means 14 for attachment shown in FIG. 2 are openings which would facilitate the throughpassage of bolts or rivets to fix the IP support structure 10 to the A pillars. Fixing surfaces 16 are positioned on the IP support structure for fixing to the screen rail so as to secure the IP support structure 10 to the vehicle frame rearward of the firewall. The IP support structure also has fixing surfaces 18 for fixing it to the tunnel which houses the steering column.

The IP support structure has mounting surfaces 20 to which vehicle components such as the steering column, passenger airbag, wiring harness, electrical modules, electronics, ducting, and the dashboard and console may be attached. The number and specific locations of the mounting surfaces 20 would be determined by the features of design, appearance, and instrumentation selected by the designers of a given vehicle.

In the IP support structure 10 according to the present invention, the fixing surfaces 14, 16, 18 are linked to the mounting surfaces 20 by ribs 22 to form an open space frame structure. The ribs 22 are sized, shaped and positioned to create critical load paths between the fixing and mounting surfaces to maintain the required shape, positioning and strength of the IP support structure, while eliminating extraneous metal skin and flat surfaces. The ribs may have a cross sectional profile selected from the group comprising, flat beam, L beam, I beam, T beam, and channel beam. Metal material is only positioned where it is needed for to maintain the structural integrity and function of the IP support structure.

The IP support structure 10 is preferably constructed of magnesium alloy which is die cast in the conventional manner. Magnesium alloys of the AM series are preferred for casting the instrument panel structure, although other alloys may also be used. A person skilled in the art would readily determine preferred magnesium alloys from which to cast the instrument panel support structure.

In order to design an instrument panel support structure it is necessary to select the fixing and mounting surfaces for the instrument panel structure. The fixing and mounting surfaces are dictated by the needs of the customer for the particular instrument panel support structure being designed. Considerations such as the size and model of the vehicle, the nature of the instruments to be attached and the desired positioning of the instruments would be factors which influence the selection of locations for the fixing and mounting surfaces. The customer would specify the size and position of steering column, the airbags to be installed, radios, dials and cabin panel displays for installation etc. Once the components and their desired positioning is known, the instrument panel support structure can be designed to accommodate the components. In effect, the fixing and mounting surfaces start as points or surfaces in space. There are three principle attachment places for the steering column, and the instrument panel support structure is designed to have the strength and stiffness to support the steering column at the A pillar (fixing surfaces 12,12), the cowl (fixing surfaces 16, 16) and the tunnel (fixing surfaces 18, 18).

The instrument panel support structure of the present invention is designed using a computer aided engineering platform. The CATIA™ program from Dassault Systems, is a suitable engineering platform with which to work, though other comparable programs such as UNI-GRAPHICS™ from EDS or I-DEAS™ from SDRC may be used. The first step is inputting the positioning coordinates of selected fixing and mounting surfaces for the instrument panel support structure in accordance with customer specification.

The next step is inputting performance requirements for stiffness and crashworthiness of the instrument panel support structure. Specific noise, vibration and harshness (NVH) standards must be met when developing an instrument panel structure. Similarly, dynamic side impact (DSI, offset deformable barrier (ODB) and fixed frontal barrier (FFB) are amongst the crash load-cases for federal validation tests that are simulated to determine how much material must exist at a given location so the structural requirements are met. The performance requirements (also referred to as load cases) are based upon the performance specifications which the customer (typically an vehicle designer or manufacturer) dictates and provides. Typically the load cases are industry determined and must be in conformance with government mandated standards.

The real design difference in the present invention is stepping away from the typical die cast mind-set that the flat surfaces or skin are the starting point of the design process. The present invention employs a characterization of an instrument panel as an open space frame or truss system, with all material not necessary to the truss structure being eliminated. The fixing and mounting points are linked together with ribs to form a virtual open space frame. Links are developed between said fixing and mounting points using computer aided engineering tools to meet the specified performance requirements.

Once the fixing and mounting points are linked together with ribs to form an open space frame, a theoretical force is applied to the open space frame and the response of the open space frame to the application of force is detected. The response is compared to the performance requirements. The response is detected by monitoring strain energy and other indicators in the beams when particular loads are applied. The force loads are transported within the ribs of the structure. The monitoring provides an indication of what parts of the structure are being asked to work the hardest to bear the load. If the response does not meet the performance requirements, the open space frame is modified.

In practice, the steps of applying a theoretical force and detecting the response to the force, and comparing the response to the performance requirements are carried out using Finite Element Analysis (FEA). This technique uses the simulation software to simulate the forces applied in the various federal validation tests identified above to determine how much material must exist at a given location so the structural requirements are met. FEA involves dividing the structure (in this case, the open space frame for the instrument panel support structure) up into small elements, a technique commonly referred to as meshing. Then an appropriate material model is selected. In accordance with the present invention one would specifying a model selected from either magnesium or magnesium alloy. Next, the boundary conditions are set. This refers to the manner in which the part is held or fixed for testing. The next step is inputting forces or loads to be applied in the test. The computer then calculates element by element the reaction of the material open space frame. Next the outputs of the test are measured. The measurable outputs can be selected from the group consisting of stress, strain, strain energy, deflection, resultant stiffness, force, resultant force, fatigue data, and frequency response.

The support of the steering column is a principal function of the instrument panel structure, and this function dictates the primary design characteristics of the instrument panel structure. In essence, a triangular support frame is required to fulfill the function of supporting the steering column. Once the overall truss structure is stiff enough, having been designed to support the steering column, the remaining modifications will be in the nature of local changes to facilitate the attachment of the components.

The possible modifications to the open space frame include, adding or removing at least one of the ribs, and/or changing the position, shape or thickness of at least one of the ribs. The aim is to decrease the strain energy at points where it is highest. The design of the IP support structure is developed by adjusting the shape, position, thickness and structure of the ribs through iterations of the design. For example one can change the configuration of a rib to a stronger profile, for example changing a flat beam to an “L” beam or an “I” beam. One or more of the ribs may have a cross sectional profile selected from the group comprising, flat beam, L beam, I beam, T beam, and channel beam. The modification of the existing rib segments (as opposed to the number and position of ribs) is in the nature of a secondary adjustment to the instrument panel support structure design. Unless the basic geometry of the IP support structure has been determined correctly, it is not possible to correct for inability to bear loads by merely making a rib segment thicker.

Other load cases, for example for air bag support and installation are added to the design calculations. Typically it will be necessary to re-iterate the steps of modifying, applying theoretical force, detecting the response and comparing the response to the performance requirements numerous times. The iterations continue until the open space frame complies with all of the performance requirements for stiffness and crashworthiness, whereby a compliant virtual open space frame is created. The shape, positions, and dimensions, of the fixing surfaces, the mounting surfaces, and the ribs of the compliant virtual open space frame as manufacturing specifications of the instrument panel support structure.

Design according to this principle attempts to eliminate as much of the face of the instrument panel as possible while still maintaining as good or better load bearing and crash worthiness characteristics when compared to conventional instrument panel support structures. It is difficult to reverse engineer an instrument panel support structure when all of the packaging and attachment means for instruments and other components are pre-determined to coincide with conventional instrument panel structures. Generally speaking, attachment in those instances requires a flat vertical mounting surface. If the instrument support panel is designed starting from first principles then the resultant panel is a truss structure of beams. The orientation of fixing points to facilitate attachment of component parts can be designed as a secondary matter. For example, attachment mechanisms can be rotated 90% to engage components, or fasteners can be developed to clip over the ribs of the instrument panel support structure.

After the design of the IP support structure is created and manufacturing specifications are generated, a die casting mold is manufactured by conventional means to the specifications determined during the design process. An instrument panel support structure of light weight die cast magnesium may then be cast in the die casting mold. After casting, the instrument panel will undergo conventional trimming and de-burring.

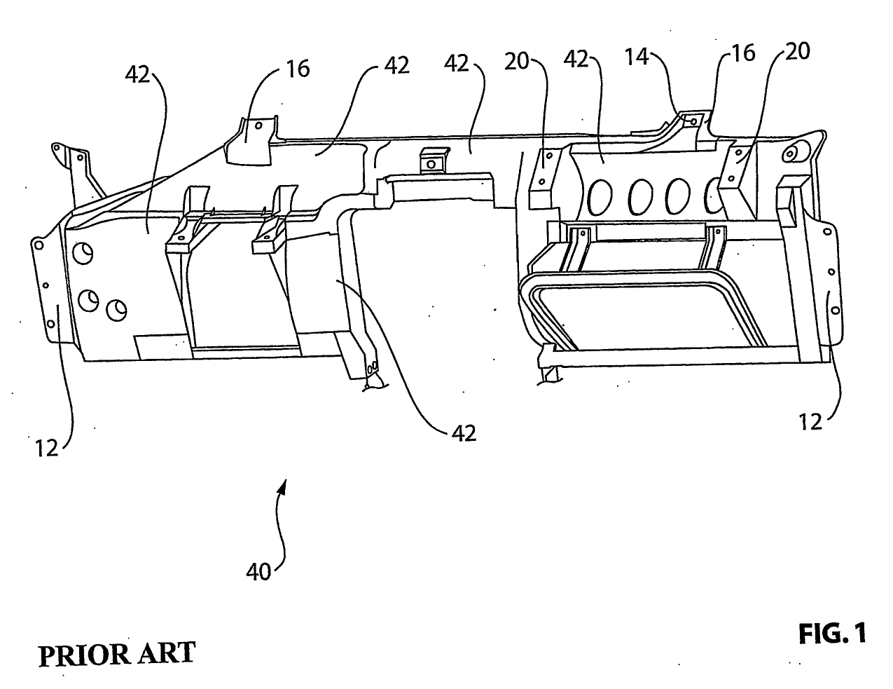

The functionality, stiffness and crashworthiness of an IP support structure according to the present invention (FIG. 2) are maintained when compared to the traditional design as shown in FIG. 1. The method of the present invention results in the elimination of a cast metal skin surface as part of the structure. This elimination reduces the weight of the cast magnesium IP support structure and also reduces the projected area of the IP support structure. The projected area of a object is a key factor in determining the type and strength of a die casting machine needed to cast the object. As the projected area of the object increases, the need for larger and more robust casting machinery increases dramatically. There are corresponding increases in manufacturing costs. By eliminating much of the cast metal skin surface of an IP structure, the method of the present invention results in structure which has a significantly smaller projected area, while maintaining the fixing and mounting surfaces with the strength and stiffness required for the functionality of the IP support structure. By comparison to the traditional design, the projected area may be reduced by over 45% and the weight reduced by 25%. The decreased projected area allows the IP support structure to be manufactured using a smaller die casting machine to produce the part. Alternatively, it may be possible to increase the number of die cavities in an existing die casting machine, thereby increasing the rate of manufacturing output by producing multiple IP support structures simultaneously.

The open sections in an open space frame IP support structure according to the present invention allow additional packaging flexibility for components to be packaged around or fixed to the IP structure. The design methods of the present invention can be adapted for use in the manufacture of other structures both for vehicular and non-vehicular applications. For example a vehicle seat frame structure or a vehicle front-end structure could be designed using a beam truss concept for die cast magnesium manufacturing. As a general prediction, any structural elements that do not rely on flat wall surface or skin for their primary function, or that does not require an enclosure, could be adapted to the truss concept.

### EXAMPLE 1

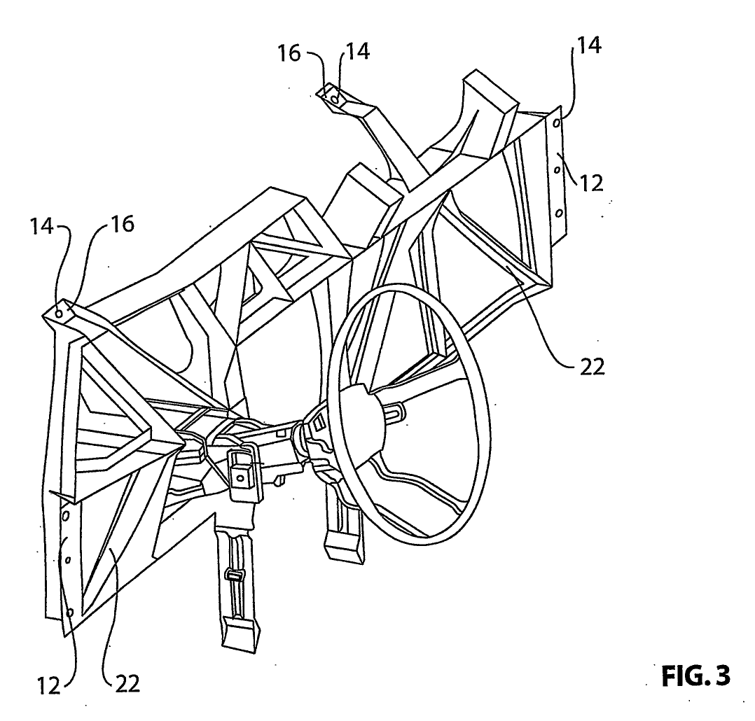

A first example of the IP support structure is illustrated in FIG. 1-FIG. 4 of the drawings. FIG. 1 shows a conventional prior art instrument panel support structure 40 constructed from cast magnesium. The conventional IP support structure has fixing surfaces 12 for attachment of the IP support structure 10 to the A pillars. Fixing surfaces 16 are positioned on the IP support structure for fixing to the screen rail so as to secure the IP support structure 10 to the vehicle frame rearward of the firewall. The IP support structure also has fixing surfaces 18 to connect it to the tunnel which houses the steering column. The conventional IP support structure has mounting surfaces 20 to which vehicle components may be attached. The conventional IP support structure 40 has a projected area of 330,000 mm² and weighs 5.1 kg. Much of the weight and projected area are the results of the large areas of panel facing 42.

The instrument panel support structure 10 shown in FIG. 2 is constructed according to the present invention. The resulting structure has the fixing surfaces and the mounting surfaces at the same relative surface for attachment to the vehicle frame and for mounting of components, but the excess magnesium panel facings are not present. All extraneous material has been eliminated, leaving only ribs 22 in an open space frame structure which connect the various fixing surfaces and mounting surfaces in the appropriate positions, to support the critical load paths required for structural performance. In this example, the instrument panel support structure according to the present invention has a projected area of 176,000 mm² and weighs 3.8 kg. This represents a weight saving of 1.3 kg over the convention IP structure.

Performance tests were conducted using known computer assisted engineering programs in order to compare the functionality of the two structures. A test was conducted for compliance with noise, vibration and harshness (NVH) standards. Testing in the first vertical mode showed the presence of 41.16 Hz for the IP support structure 10 according to the present invention and the presence of 41.2 Hz in the first vertical mode for the conventional IP support structure 42. Thus, the NVH performance of the IP support structure having an open space frame was comparable to the performance of the conventional IP support structure under the same test conditions.

Simulated crash testing was also conducted using computer assisted engineering programs. In a simulation of a crash at 40 mph and a 40% offset, the there was local buckling but no failure predicted in tests for both the conventional and the subject IP structures.

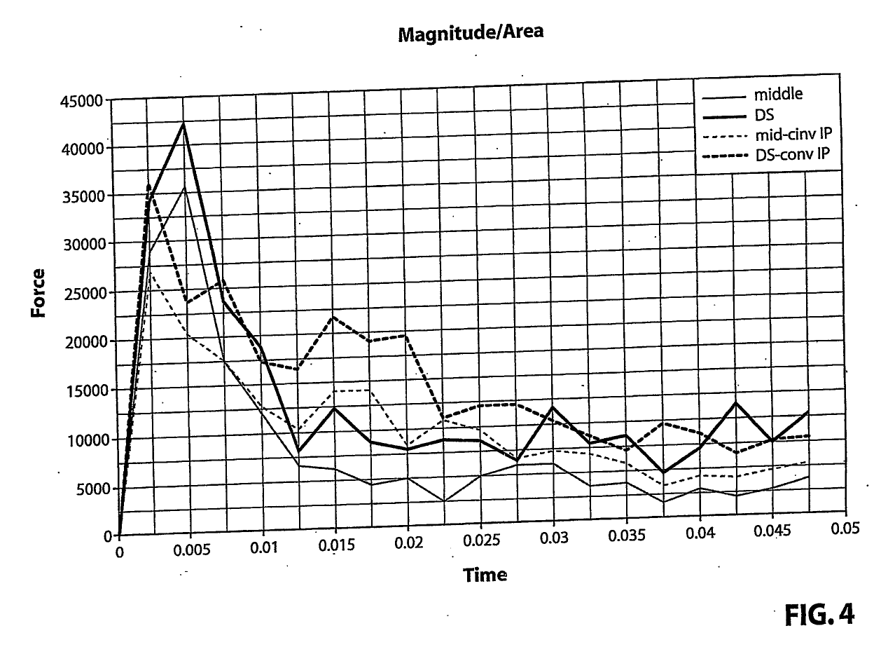

Column stiffness tests were also conducted. The first test examined a rigid column beam in a fixed bedplate. A force of 11565 N was applied at a position 30° to the X axis, and the resulting deflection was measured. FIG. 4 shows the relative performance of the IP structures in impact tests. The stiffness of the conventional IP support structure was determined to be 22513 N/mm. The stiffness of the IP support structure according to the invention was determined to be 24810 N/mm. Thus the IP rib structure of the present invention outperformed the conventional structure in this test. Vertical column stiffness test showed also showed superior performance when compared with the conventional structure. In tests having an application of a force of 225 N the resultant stiffness was 3250N/mm for the invention, compared with 2467N/mm for the conventional structure. In side impact testing, the instrument panel support structure according to the present invention withstood the same peak loading as the conventional structure. The results of the comparative tests are summarized in the following table.

TABLE 1
Summary of Test Results - Example 1

| | Conventional | | Invention | |
|---|---|---|---|---|
| Test Parameters | IP Structure | | IP Structure | |
| NVH -COLUMN MODEL- | 41.2 | Hz | 41.16 | Hz |
| vertical | | | | |
| Column Stiffness - | 22513 | N/mm | 24810 | N/mm |
| 30° to the X axis | | | | |
| rigid column beam | | | | |
| force applied 22565 N | | | | |
| Column Stiffness - | 2467 | N/mm | 3250 | N/mm |
| Vertical rigid | | | | |
| column beam 225 | | | | |
| N normal to column | | | | |

| | |
|---|---|
| PAB Loading - | local bending with |
| decelerate 56 kph | effective plastic strain |
| to 0 kph | about 4% |
| Side Impact - moved | same peak load as |
| Section Force: | conventional |
| Driver Side | |

### EXAMPLE 2

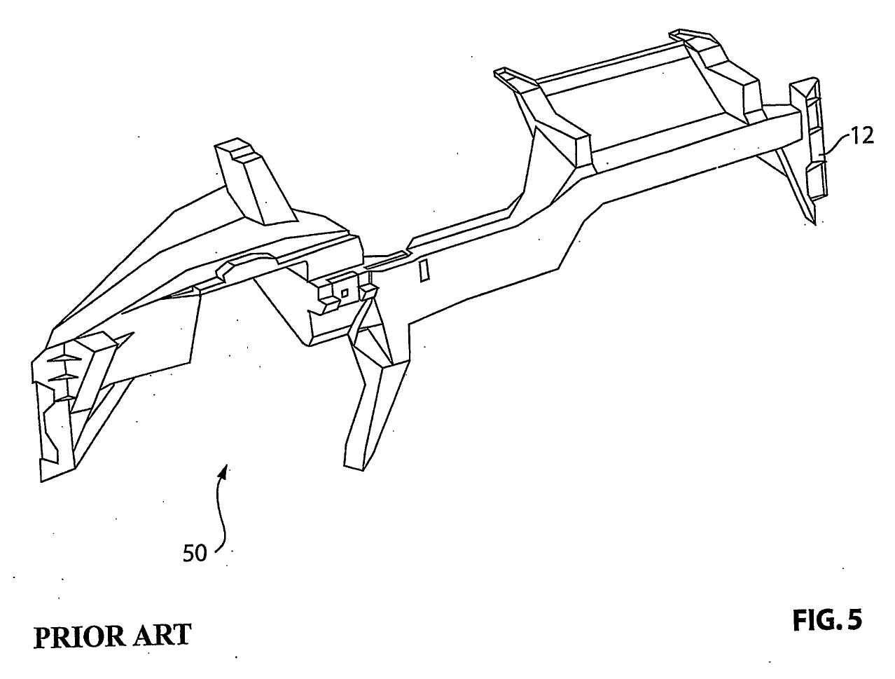

The second example is illustrated in FIG. 5 through FIG. 7. FIG. 5 shows a conventional prior art instrument panel support structure 50 constructed from cast magnesium. The conventional IP support structure has fixing surfaces for attachment to the vehicle frame and mounting surfaces to which vehicle components may be attached. The conventional IP support structure 50 has a projected area of 330,000 mm² and weighs 13.0 lbs. Much of the weight and projected area are the results of the large areas of panel facing.

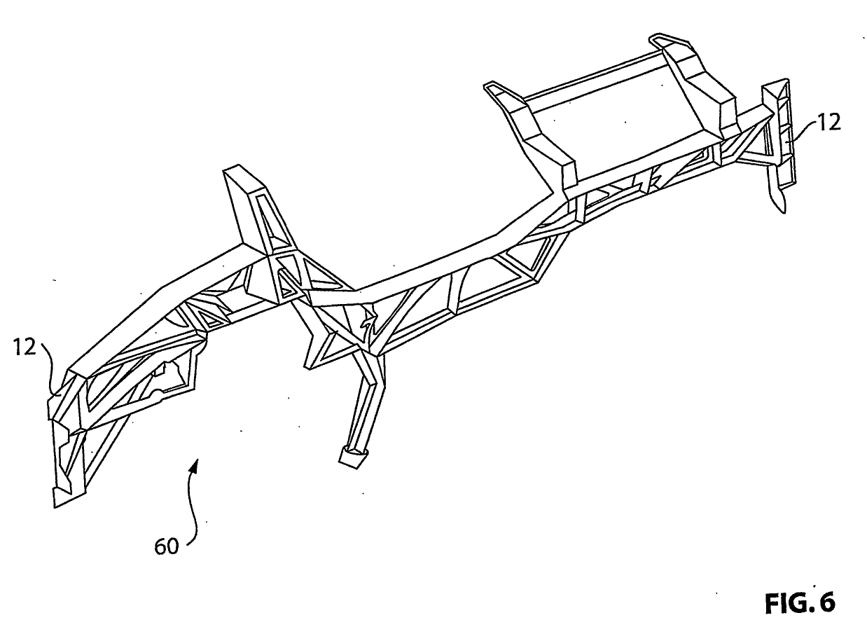

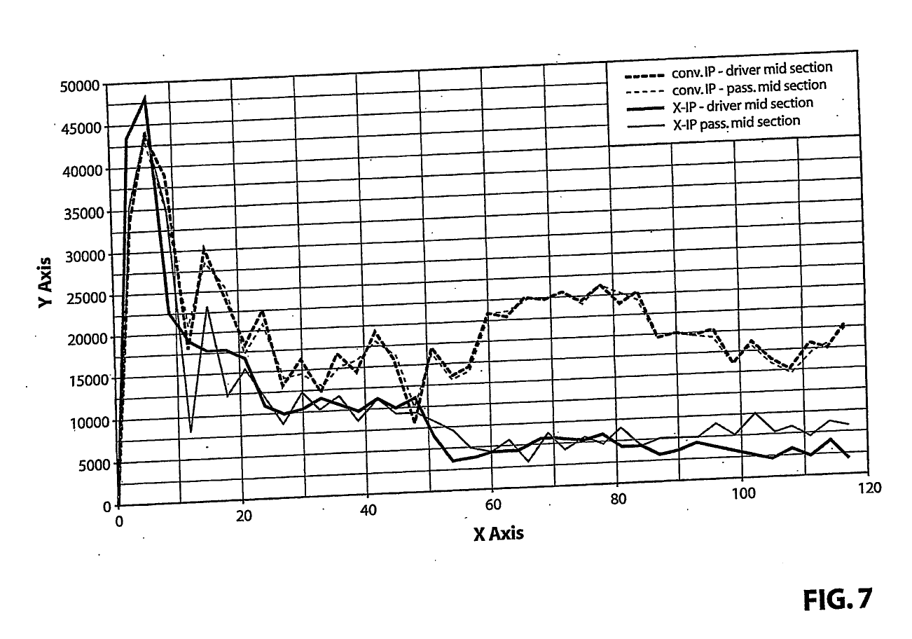

The instrument panel support structure 60 shown in FIG. 6 is constructed according to the present invention. The resulting structure has the fixing surfaces and the mounting surfaces at the same relative positions for attachment to the vehicle frame and for mounting of components, but the excess magnesium panel facings are not present. All extraneous material has been eliminated, leaving only ribs in an open space frame structure which connect the various fixing surfaces and mounting surfaces in the appropriate positions, to support the critical load paths required for structural performance. In this example, the instrument panel support structure according to the present invention has a projected area of 160,000 mm² and weighs 10.1 lbs. This represents a weight savings of 2.9 lbs over the convention IP structure. Computer assisted engineering programs were used to conduct the following performance tests: NVH, column stiffness, PAB (passenger air bag loading), crash test 40% at 35 mph offset, side Impact, and 2 g sag. The IP support structure constructed according to the present invention achieved comparable performance testing results to the conventional structure. The specific results are summarized in the following table 2. FIG. 7 is a graph illustrating comparable performance of the two structures in impact tests.

TABLE 2
Summary of Test Results - Example 2

| | Conventional | | Invention | |
|---|---|---|---|---|
| Test Parameters | IP Structure | | IP Structure | |
| NVH -COLUMN MODEL-45 Hz | 37.96 | | 37.25 | |
| vertical | | | | |
| Requirements: 35-37 Hz | | | | |
| NVH -COLUMN MODEL-45 Hz | 47.4 | | 46.8 | |
| horizontal | | | | |
| Column Stiffness - Vertical | 501 | | 516 | |
| Requirements: withstand 500 N/mm | | | | |
| Column Stiffness - Lateral | 1472 | | 1722 | |
| Requirements: withstand 1100 N/mm | | | | |
| PAB Loading - maximum stress | 57 | MPa | 82 | MPa |
| 2 g Sag Loading | 3.11 | mm | 3.03 | mm |
| 28 Kg added mass --maximum | | | | |
| deflection | | | | |
| 35 mph 40% offset crash - | 250 | mm | 44.9 | mm |
| X-deflection | | | | |
| Requirements: 125 mm | | | | |
| 35 mph 40% b offset crash - | 125 | mm | 71 | mm |
| Z-deflection | | | | |
| Requirements: 75 mm | | | | |
| Side Impact - moved 1500 mm | 36409 | N | 42162 | N |
| in y in 50 ms | | | | |
| Section Force: Driver Side | | | | |
| Requirements: 42000 N | | | | |
| Side Impact - moved 1500 mm | 26632 | N | 35801 | N |
| in y in 50 ms | | | | |
| Section Force: Middle | | | | |

Although the present invention has been described in terms of preferred embodiments, it will be understood, of course, that the invention is not limited thereto since modifications may be made by those skilled in the art, particularly in light of the foregoing teachings. Accordingly, the scope of the present invention is limited only by reference to the following claims.

We claim:

1. An instrument panel support structure having fixing surfaces for fixation to a vehicle frame, and mounting surfaces for mounting vehicle components thereto, said fixing surfaces and mounting surfaces being linked together by ribs to form an open space frame structure.

2. The instrument panel support structure of claim 1 wherein the ribs are sized, shaped and positioned to create critical load paths.

3. The instrument panel support structure of claim 2 being cast of magnesium alloy.

4. The instrument panel support structure of claim 3 wherein at least two of the fixing surfaces are positioned and shaped for fixation of the instrument panel support structure to the two A-pillars of a vehicle frame.

5. The instrument panel support structure of claim 4 wherein at least one of the fixing surfaces is positioned and shaped for fixation to a vehicle frame at a position rearward of the firewall thereof.

6. The instrument panel support structure of claim 5 wherein at least one of the fixing surfaces is positioned and shaped for fixation to a vehicle frame at the steering column tunnel.

7. The instrument panel support structure of claim 2 wherein the ribs have a cross sectional profile selected from the group comprising, flat beam, L beam, I beam, T beam, and channel beam.

8. A method of designing an instrument panel support structure using a computer aided engineering platform, comprising the steps of:
(a) inputting the positioning coordinates of selected fixing and mounting surfaces for the instrument panel support structure;
(b) inputting performance requirements for stiffness and crashworthiness of the instrument panel support structure;
(c) linking said fixing and mounting points together with ribs to form virtual open space frame;
(d) applying theoretical force to the open space frame;
(e) detecting the response of the open space frame to the application of force; and,
(f) comparing the response to the performance requirements.

9. The method of claim 8, further comprising the steps of:
(g) modifying the open space frame; and,
(h) reiterating steps (d) through (g) until the open space frame complies with said performance requirements for stiffness and crashworthiness;
whereby a compliant virtual open space frame is created.

10. The method of claim 9, wherein the step of (g) modifying the open space frame comprises re-positioning at least one rib.

11. The method of claim 10, wherein the step of (g) modifying the open space frame comprises adding at least one rib.

12. The method of claim 10, wherein the step of (g) modifying the open space frame comprises removing at least one rib.

13. The method of claim 10, wherein the step of (g) modifying the open space frame comprises changing the cross sectional profile of at least one rib.

14. The method of claim 11, further comprising the step of recording the shapes, positions and dimensions of the fixing surfaces, mounting surfaces, and ribs of the compliant virtual open space frame as manufacturing specifications of the instrument panel support structure.

15. The method of claim 14, further comprising the step of constructing a die casting mold according to the specifications.

16. The method of claim 15, comprising the further step of casting an instrument panel support structure of light weight die cast magnesium in the die casting mold.

17. The method of claim 8, wherein the steps of (d) applying theoretical force to the open space frame; (e) detecting the response of the open space frame to the application of force; and (f) comparing the response to the performance requirements are conducted by finite element analysis.

18. The method of claim 17, wherein the finite element analysis comprises the steps of:
(i) meshing the open space frame;
(ii) selecting a material model;
(iii) setting boundary conditions;
(iv) inputting forces to be applied;
(v) calculating element by element the reaction of the open space frame; and,
(vi) measuring outputs.

19. The method of claim 18, wherein the material model of step (ii) is selected from the group consisting of magnesium, magnesium alloy.

20. The method of claim 19, wherein the outputs are selected from the group consisting of stress, strain, strain energy, deflection, resultant stiffness, force, resultant force, fatigue data, and frequency response.
